(19) United States
(12) Patent Application Publication
(10) Pub. No.: US 2024/0204447 A1
(43) Pub. Date: Jun. 20, 2024

(54) Connector

(71) Applicant: Tyco Electronics Japan G.K., Kawasaki-shi (JP)

(72) Inventor: Kentaro Yoshimura, Kawasaki-shi (JP)

(73) Assignee: Tyco Electronics Japan G.K., Kawasaki-shi (JP)

(21) Appl. No.: 18/539,685

(22) Filed: Dec. 14, 2023

(30) Foreign Application Priority Data
Dec. 14, 2022 (JP) 2022-199131

(51) Int. Cl. H01R 13/52

(52) U.S. Cl. CPC H01R 13/5202; H01R 43/005

(57) ABSTRACT

A connector comprises a waterproof structure including a first potting reservoir, a first visual indicator, and a potting agent injected into the first potting reservoir. The first potting reservoir is recessed in an area including an edge of a contact part of a plurality of connector components coming into contact with one another. The first indicator identifies a desired amount of the potting agent to be injected into the potting reservoir.

### CROSS-REFERENCE TO RELATED APPLICATION

This application claims the benefit of Japanese Patent Application No. 2022-199131 filed on Dec. 14, 2022, the whole disclosure of which is incorporated herein by reference.

### FIELD OF THE INVENTION

The present disclosure relates to a connector with a waterproof structure.

### BACKGROUND

Connectors having a waterproof structure are conventionally known. For example, a prior art connector includes a signal contact extending in the form of a bar and a cylindrical outer shield surrounding the signal contact at a distance from that signal contact. The connector further includes a structure in which a first seal member fitted between the signal contact and the outer shield, and a second seal member is fitted around the circumference of the outer shield. This connector mates with both a first mating connector on the camera module side and a second mating connector to which a cable is connected and mediates signal transmission between the camera module and the cable. When this connector is mated with the first mating connector on the camera module side and unmated with the second mating connector to which the cable is connected, the connector serves to prevent water that has entered the connector from leaking into the first mating connector on the camera module side.

In recent years, the field of connectors has seen further miniaturization and higher signal speed, so that signal contacts having a smaller diameter have been used. The smaller the diameter of the signal contact, the narrower the hole through which the signal contact is penetrated to waterproof the area around the signal contact, which may make it difficult to provide a hole that ensures sufficient waterproofing.

As means for solving this problem, a technique is known to create a potting reservoir, inject a liquid potting agent into it, and harden the potting agent to thereby ensure waterproof performance. However, it is difficult to inject a highly accurately controlled amount of potting agent into a small potting reservoir in a miniaturized connector, and there is a risk that injected potting agent will be too little to obtain sufficient waterproof performance or too much potting agent that has been injected will adversely affect assembly in the subsequent process.

### SUMMARY

According to an embodiment of the present disclosure, a connector comprises a waterproof structure including a first potting reservoir, a first visual indicator, and a potting agent injected into the first potting reservoir. The first potting reservoir is recessed in an area including an edge of a contact part of a plurality of connector components coming into contact with one another. The first indicator identifies a desired amount of the potting agent to be injected into the potting reservoir.

### BRIEF DESCRIPTION OF THE DRAWINGS

The invention will now be described by way of example with reference to the accompanying Figures, of which:

FIG. 1 is an isometric view of a connector according to one embodiment of the invention;

FIG. 2 shows an example of the use of the connector shown in FIG. 1;

FIG. 3 is a disassembled isometric view of the connector shown in FIG. 1;

FIG. 4 is a vertical cross-sectional view of the connector shown in FIG. 1;

FIG. 5 is a bottom view of the connector shown in FIG. 1 viewed from the bottom;

FIG. 6 is an isometric view of the first and second potting reservoir sections;

FIG. 7 is an isometric view of the first and second potting reservoir sections, as shown in FIG. 6;

FIG. 8 is an isometric view showing one part of the first potting reservoir before a potting agent is injected;

FIG. 9 shows an example of the indicators formed on the inner wall surface of the outer shield; and

FIG. 10 is an isometric view showing one part of the second potting reservoir before a potting agent is injected.

### DETAILED DESCRIPTION OF THE EMBODIMENTS

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

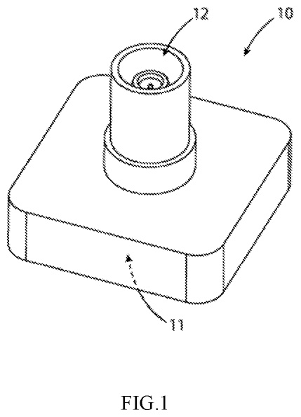

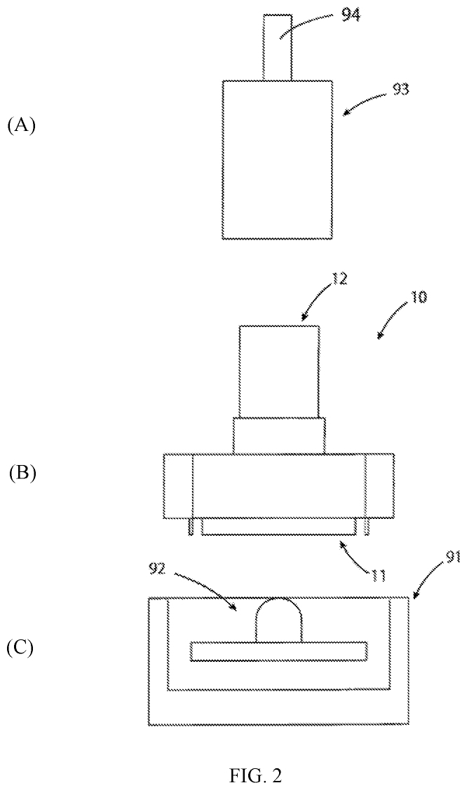

FIG. 1 is an isometric view of a connector 10 as one embodiment of the invention. FIG. 2 is an example of the use of the connector 10 shown in FIG. 1. As shown in FIGS. 1 and 2, the connector 10 has a first mating part 11 on the lower side and a second mating part 12 on the upper side in the posture shown in FIG. 2. The connector 10 is mated with a first mating connector 92, which is stored or arranged in a case 91, in such a way that the first mating connector 92 is covered with the first mating part 11. In the example shown here, the first mating connector 92 is a connector embedded in a module in which a camera is mounted and is adapted to send signals from the camera to the outside. The upper second mating part 12 mates with a second mating connector 93. A cable 94 (only a portion of which is shown) is connected to the second mating connector 93.

The connector 10 shown in FIG. 2 (B) mates with both the first mating connector 92 and the second mating connector 93 and mediates signals transmitted between them. The first mating connector 92 is a connector that is incorporated into a module with a built-in camera to be installed in a car and serves to send signals from that camera. The connector 10 shown in FIG. 2 (B) receives the signals from the camera from the first mating connector 92 and transmits them to the second mating connector 93. The cable 94 is connected to the second mating connector 93, and the signal conveyed to the second mating connector 93 is transmitted by the cable 94 to a device, such as a monitor at a remote location.

The connector 10 is mated with the first mating connector 92 in the manufacturing process of a car or in the maintenance process of a car. Since the module equipped with a camera is subject to damage when exposed to moisture, the connector 10 must be a connector in which waterproof measures are taken. These measures ensure that water entering the connector 10 does not leak to the first mating connector 92 side, even if the connector is not mated with the second mating connector 93. The waterproofing of the connector 10 at a stage prior to mating with the second mating connector 93 and is called pre-mating waterproofing or unmated waterproofing.

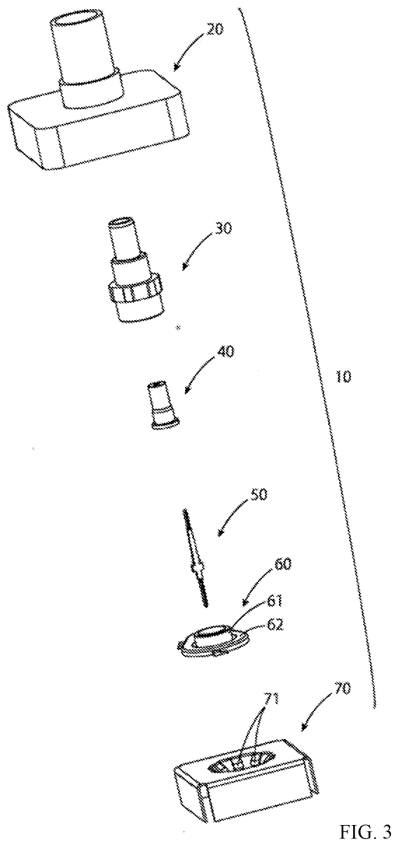

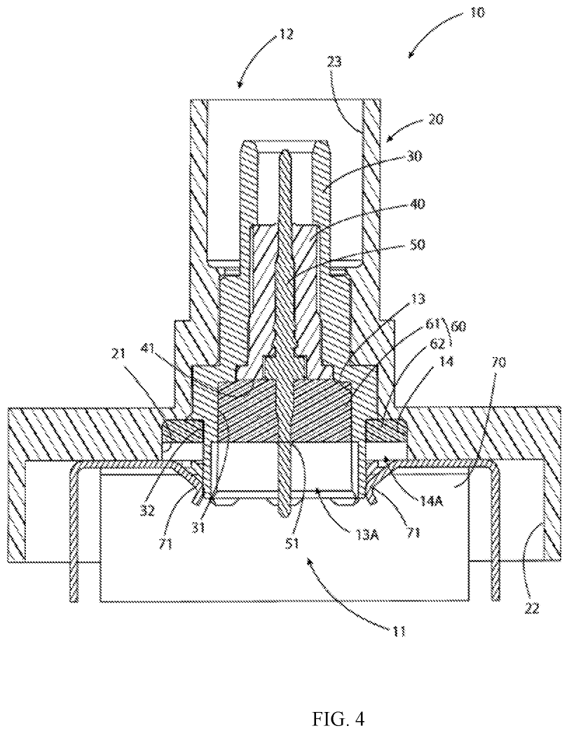

FIG. 3 is a disassembled isometric view of the connector shown in FIG. 1. FIG. 4 is a vertical cross-sectional view of the connector shown in FIG. 1. The connector 10 has, in order from the top shown in FIG. 3, a plastic outer housing 20, a metal outer shield 30, a plastic inner housing 40, a metal signal contact 50, a potting mass 60, and a metal case shell 70.

The signal contact 50 has a rod shape and serves to receive signals from the camera from the first mating contact 92 shown in FIG. 2 and transmit them to the second mating contact 93. The signal contact 50 is supported by the inner housing 40. The outer shield 30 is a cylindrical member, supports the inner housing 40 therein, and further supports the signal contact 50 at its center.

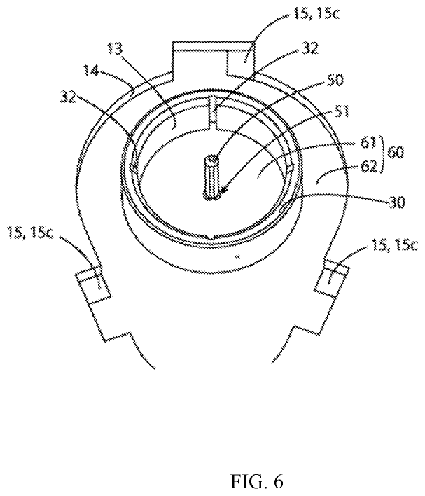

The potting mass 60 serves to waterproof the connector 10. The shape of the potting agent as a mass after curing is shown here. The potting mass 60 is divided into an inner first potting mass 61 and an outer second potting mass 62. These potting masses 61, 62 are cured by the injection of liquid potting agent into two potting reservoirs 13, 14 shown in FIG. 6 during the process of assembling the connector 10. The potting masses 61, 62 are originally inseparable from the components that compose the potting reservoirs 13, 14. However, in FIG. 3, the potting masses 61, 62 after curing are taken out on purpose so as to show their shapes. Then, a liquid potting agent is injected into the two potting reservoirs 13, 14 and cured to complete the waterproof structure.

Both of the two potting reservoirs 13, 14 are formed into a depression being recessed in an area including the edge of the contact part of a plurality of components of the connector 10 that are in contact with one another. Specifically, the first potting reservoir 13 is formed into a depression being recessed around that part of the signal contact 50 which projects downward from the inner housing 40. That is, the first potting reservoir 13 is formed in an area that includes the contact part between the signal contact 50 and the inner housing 40 and the contact part between the inner housing 40 and the outer shield 30. The first potting reservoir 13 is partitioned by the signal contact 50, a bottom surface 41 of the inner housing 40, and an inner wall surface 31 of the outer shield 30. The second potting reservoir 14 is formed in an area that includes the contact part between the outer shield 30 and the outer housing 20 and is partitioned by an outer wall surface 32 of the outer shield 30 and an inner wall surface 21 of the outer housing 20.

Both the first potting reservoir 13 and the second potting reservoir 14 have an opening in the same direction, specifically an opening opened downward in FIG. 4. Therefore, in injecting a potting agent into the first potting reservoir 13 and second potting reservoir 14, the connector 10 before assembling the case shell 70 is held upside down relative to the posture shown in FIG. 4, and, while keeping the state of being upside down, a potting agent is injected into the first potting reservoir 13 and the second potting reservoir 14 until the injected potting agent is cured to form the potting masses 61 and 62. As both the first potting reservoir 13 and the second potting reservoir 14 have the same downward opening, the potting agent can be injected into both the first potting reservoir 13 and the second potting reservoir 14 with the connector 10 held upside down. Further explanation of potting will be described later.

The case shell 70 is installed after a potting agent is injected into the first potting reservoir 13 and the second potting reservoir 14 and then cured. The section 71 of the case shell 70 is into contact with the outer shield 30, so that the case shell is kept at ground potential. When the connector 10 is mated with the first mating connector 92, the connector 10 covers the first mating connector 92 and comes into contact with the ground (not shown) of the first mating connector 92 to shield the first mating connector 92.

The outer housing 20 has a first mating opening 22, which is wide open below the outer housing 20, and a second mating opening 23, which is open above the outer housing 20. The case shell 70 is positioned in the first mating opening 22. When the connector 10 is mated with the first mating connector 92, the case shell 70 covers the first mating connector 92 and the outer housing 20 fits into the case 91. The second mating opening 23 is mated with a second mating connector 93, where the second mating connector 93 fits into the second mating opening 23.

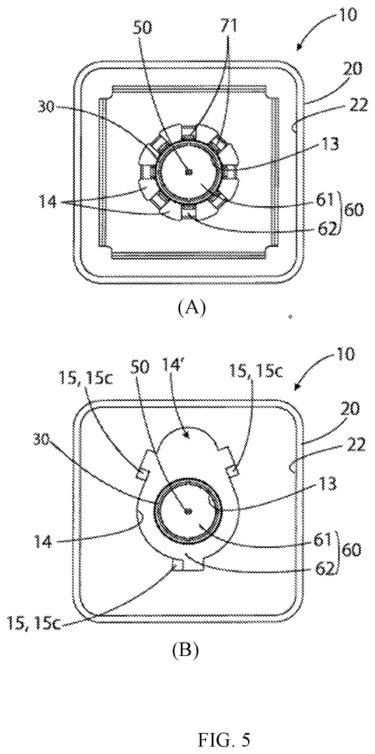

FIG. 5 is a bottom view of the connector shown in FIG. 1 viewed from the bottom. More specifically, FIG. 5 (A) is a bottom view with the case shell attached, and FIG. 5 (B) is a bottom view with the case shell removed. FIG. 6 is an isometric view of the first and second potting reservoir sections.

As set forth above, a potting agent is injected into the first potting reservoir 13 and the second potting reservoir 14 with the connector 10 in the upside-down position during assembly. A potting agent is injected into the first potting reservoir 13 and the second potting reservoir 14 in a posture in which the connector 10 under assembly is held upside down. As shown in FIG. 5 (A), the case shell 70 is spread inside the first mating opening 22 of the outer housing 20. Then, the section 71 of the case shell 70 is into contact with the outer shield 30, so that the case shell 70 is kept at ground potential.

The signal contact 50 is shown in the center of the outer shield 30. The first potting reservoir 13 is formed in an area surrounded by the outer shield 30, the area being an area around the signal contact 50, and the first potting mass 61 is formed in the first potting reservoir 13 by the potting agent injected therein. The second potting reservoir 14 is formed on the outside of the outer shield 30. Then, in that second potting reservoir 14, the second potting mass 62 is formed by the potting agent injected therein. The second potting reservoir 14 is only partially visible in FIG. 5 (A) from between the sections 71 of the case shell 70. Its entire shape is shown in FIG. 5 (B) and FIG. 6.

One part 14′ of the second potting reservoir 14 in the circumferential direction around the outer wall 32 of the outer shield 30 is wider than the part excluding the one part 14′. This is to relax the alignment accuracy of the nozzle (not shown) for injecting the potting agent with respect to the second potting reservoir 14. Further, by forming the widened part 14′, the work of injecting the potting agent is made efficient.

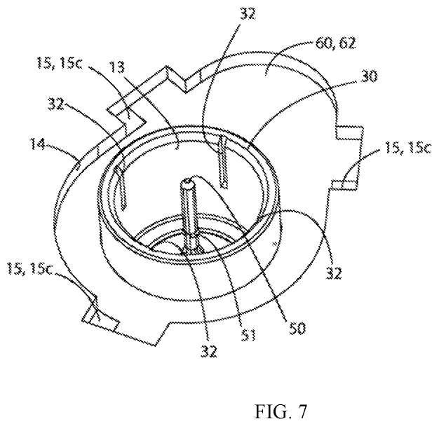

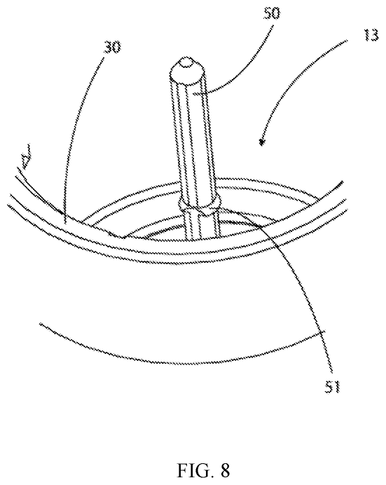

FIG. 7 is an isometric view of the first and second potting reservoir sections, as in FIG. 6. However, in FIG. 7, the first potting reservoir 13 before a potting agent is injected is shown. For the second potting reservoir 14, a potting agent has already been injected, as shown in FIG. 6. FIG. 8 is an isometric view showing one part of the first potting reservoir before a potting agent is injected.

The signal contact 50 has a brim 51 protruding in the center of the first potting reservoir 13 in a horizontal direction relative to the vertical direction in which the signal contact 50 extends. This brim 51 serves as an indicator of the proper amount of potting agent to be injected into the first potting reservoir 13. That is, when a potting agent is injected into the first potting reservoir 13, the potting agent is injected to a height that reaches the brim 51. The brim 51 also serves to prevent the potting agent from travelling further upward along the wall surface of the signal contact 50 due to surface tension when a potting agent is injected into the first potting reservoir 13. This maintains the reliability of the signal transmission performance of the signal contacts 50.

As further shown in FIG. 7, the inner wall 31 of the outer shield 30 has a groove 32 extending to the midway depth of the inner wall 31. This groove 32 also serves as an indicator of the proper amount of potting agent to be injected into the first potting reservoir 13. This means that when a potting agent is injected up to the height of the bottom edge of the groove 32, the proper amount of potting agent has been injected. Here, grooves 32 are formed at four locations in the circumferential direction. This means that the grooves 32 also serve as indicators to show whether the connector 10 is tilted when injecting a potting agent.

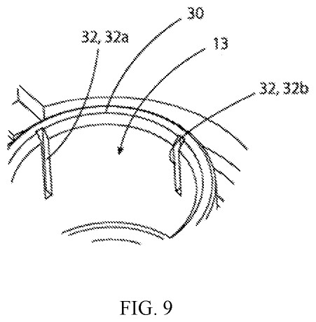

FIG. 9 shows an example of a variation of the indicators formed on the inner wall surface of the outer shield. In FIG. 9, grooves 32 are formed on the inner wall 31 of the outer shield 30 extending to the midway depth, similar to FIG. 7. However, the two grooves 32a and 32b shown in FIG. 9 have different lengths from each other. That is, the groove 32a extends closer to the bottom of the first potting reservoir 13 than the groove 32b. If the potting agent injected into the first potting reservoir 13 does not reach the bottom of the groove 32a, it means that the injected amount is too little. On the other hand, if the injected potting agent reaches the bottom end of the groove 32b, it means that the injected amount is too much. In this way, a plurality of indicators may be combined to point to the upper and lower limits of the injection volume. Although the groove 32 is used as an indicator here, the indicator does not have to be a groove; it may be a projection, a protrusion, or the like.

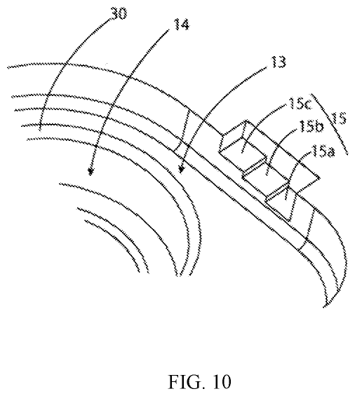

FIG. 10 is an isometric view showing one part of the second potting reservoir before a potting agent is injected. On the periphery of the second potting reservoir 14, three flights of stairs 15 shown in FIG. 9 are formed at three locations in the circumferential direction, as shown in FIG. 5 (B). The three flights of stairs 15 serve as indicators of the amount of potting agent injected into the second potting reservoir 14. If the first step of the stairs 15a, the lowest of the three flights of stairs 15, is not filled with potting agent, it means that the injected amount of potting agent is too little. If a potting agent is injected to the height of the second step of the stairs 15b, it means that the injected amount is just the standard injection amount. If the third step of the stairs 15c is filled with potting agent, it means that the injected amount of potting agent is too much. In other words, the three flights of stairs 15 point not only to the proper injection amount of potting agent, but also to the upper and lower limits of injection amount, that is, the allowable value of injection amount. Further, the three flights of stairs 15 are formed at three locations in the circumferential direction, the stairs 15 are useful as indicators of the inclination of the connector 10.

FIG. 5 (B) shows a state where the first step of the stairs 15a and the second step of the stairs 15b are buried in the potting agent and the third step of the stairs 15c has emerged from the potting agent surface. In this way, according to the connector of this embodiment, waterproof performance is provided by providing an indicator of injection amount and injecting the proper injection amount of potting agent, so that it is possible, for example, to adopt a small-diameter signal contact 50 that cannot be handled by waterproof rubber or the like, or to meet the demand for miniaturization of connectors.

In addition, those areas in which it is believed that those of ordinary skill in the art are familiar, have not been described herein in order not to unnecessarily obscure the invention described. Accordingly, it has to be understood that the invention is not to be limited by the specific illustrative embodiments, but only by the scope of the appended claims.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of the elements or steps, unless such exclusion is explicitly stated. Furthermore, references to “one embodiment” of the present disclosure are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. A connector having a waterproof structure, the waterproof structure comprising:
a first potting reservoir recessed in an area including an edge of a contact part of a plurality of connector components coming into contact with one another;
a first indicator identifying an injection amount of a potting agent to be injected into the first potting reservoir; and
a potting agent injected into the first potting reservoir.

2. The connector according to claim 1, wherein the first potting reservoir includes a depression circumscribing an outer wall of components of the connector.

3. The connector according to claim 2, wherein one part of the depression in a circumferential direction is wider than a remainder of the depression.

4. The connector according to claim 1, further comprising an elongated signal contact, the first potting reservoir is defined by a depression circumscribing the signal contact.

5. The connector according to claim 1, wherein the first indicator protrudes laterally with respect to a direction in which the signal contact extends in the potting reservoir.

6. The connector according to claim 1, wherein the first indicator includes a plurality of individual first indicators pointing to each of a plurality of injection volumes.

7. The connector according to claim 1, further comprising a second potting reservoir and a second indicator corresponding to the second potting reservoir, the first reservoir and the second reservoir are open in a common direction.

8. The connector according to claim 1, wherein the connector includes:
a first mating part adapted to mate with a first mating connector; and
a second mating part adapted to mate with a second mating connector, the connector adapted to pass signals between the first mating connector and the second mating connector.

9. The connector according to claim 8, wherein the waterproofing structure is adapted to prevent water entering the connector from leaking to a first side of the connector corresponding to the first mating connector when the connector is mated with the first mating connector and unmated with the second mating connector.

10. A connector, comprising:
a first mating part adapted to mate with a first mating connector on a first side of the connector;
a second mating part adapted to mate with a second mating connector on a second side of the connector; and
a waterproofing structure adapted to prevent water entering the connector from leaking to the first side of the connector when the connector is mated with the first mating connector and unmated with the second mating connector, including:
a first potting reservoir recessed in an area including an edge of a contact part of a plurality of connector components coming into contact with one another, the first potting reservoir opened in a first direction;
a first indicator identifying a first injection amount of a potting agent to be injected into the first potting reservoir;
a second potting reservoir opened in the first direction; and
a second indicator identifying a second injection amount of the potting agent to be injected into the second potting reservoir.

11. The connector according to claim 10, further comprising a signal contact, the first potting reservoir defining a depression circumscribing the signal contact.

12. The connector according to claim 11, further comprising an outer shield arranged about the signal contact, the first potting reservoir defined between the signal contact and the outer shield.

13. The connector according to claim 12, wherein the first indicator includes a groove formed into an inward facing wall of the outer shield defining the first potting reservoir.

14. The connector according to claim 12, wherein the second potting reservoir is defined between an outer surface of the outer shield and an inner surface of a housing of the connector.

15. The connector according to claim 14, wherein the second indicator comprises at least one step formed into the housing in the first direction.

16. The connector according to claim 15, wherein the second indicator comprises a plurality of the at least one step corresponding to a plurality of the second injection amounts.

17. The connector according to claim 11, wherein one part of the depression in a circumferential direction is wider than a remainder of the depression.

18. The connector according to claim 11, wherein the first indicator protrudes laterally with respect to a direction in which the signal contact extends in the potting reservoir.

19. The connector according to claim 18, wherein the first indicator includes a plurality of individual first indicators pointing to each of a plurality of injection volumes.

20. The connector according to claim 19, wherein each first indicator includes a plurality of grooves, each groove extending to a discrete height in the first direction.
